(19) United States
(12) Patent Application Publication
(10) Pub. No.: US 2025/0372304 A1
(43) Pub. Date: Dec. 4, 2025

(54) MULTILAYER CERAMIC CAPACITOR

(71) Applicant: Murata Manufacturing Co., Ltd., Nagaokakyo-shi (JP)

(72) Inventor: Hiroyasu YOSHIDA, Nagaokakyo-shi (JP)

(21) Appl. No.: 19/169,159

(22) Filed: Apr. 3, 2025

(30) Foreign Application Priority Data
May 28, 2024 (JP) 2024-086124

(51) Int. Cl. H01G 4/224; H01G 4/008; H01G 4/12; H01G 4/30

(52) U.S. Cl. CPC H01G 4/224; H01G 4/008; H01G 4/1227; H01G 4/30

(57) ABSTRACT

A multilayer ceramic capacitor includes a multilayer body including dielectric layers and inner electrode layers that are laminated, and an outer electrode to establish electrical continuity with the inner electrode layers. In the multilayer body, an outer surface at a boundary portion between an end-surface-side ineffective portion and a perpendicular ridge ineffective portion, an outer surface of the perpendicular ridge ineffective portion, and an outer surface at a boundary portion between the perpendicular ridge ineffective portion and a side-surface-side ineffective portion define a contiguous curved surface protruding outward in plan view in a lamination direction, and a protection film including carbon and silicon is provided on the curved surface.

### CROSS REFERENCE TO RELATED APPLICATIONS

This application claims the benefit of priority to Japanese Patent Application No. 2024-086124 filed on May 28, 2024. The entire contents of this application are hereby incorporated herein by reference.

### BACKGROUND OF THE INVENTION

### 1. Field of the Invention

The present invention relates to multilayer ceramic capacitors.

### 2. Description of the Related Art

In general, a multilayer ceramic capacitor includes a multilayer body that includes a plurality of dielectric layers and a plurality of inner electrode layers, the plurality of dielectric layers and the plurality of inner electrode layers being laminated, and an outer electrode that is disposed at a predetermined position in the multilayer body so as to establish electrical continuity with the inner electrode layers, and the multilayer body includes an effective portion in which the inner electrode layers overlap each other to generate capacitance and an ineffective portion surrounding the effective portion. As regions defining the ineffective portion, there are regions (hereinafter referred to as “main-surface-side ineffective portion”) that sandwich the effective portion in a lamination direction, regions (hereinafter referred to as “end-surface-side ineffective portion”) that sandwich the effective portion in a length direction intersecting the lamination direction, regions (hereinafter referred to as “side-surface-side ineffective portion”) that sandwich the effective portion in a width direction intersecting the lamination direction and the length direction, regions (hereinafter referred to as “perpendicular ridge ineffective portion”) that are disposed at four corners of the multilayer body so as to connect the end-surface-side ineffective portion and the side-surface-side ineffective portion to each other, regions (hereinafter referred to as “horizontal ridge ineffective portion”) that are disposed at four corners of the multilayer body so as to connect the main-surface-side ineffective portion and the end-surface-side ineffective portion to each other, regions (hereinafter referred to as “long ridge ineffective portion”) that are disposed at four corners of the multilayer body so as to connect the main-surface-side ineffective portion and the side-surface-side ineffective portion to each other, and regions (hereinafter referred to as “corner-portion ineffective portion”) of corner portions surrounded by the perpendicular ridge ineffective portion, the horizontal ridge ineffective portion, and the long ridge ineffective portion.

Here, ridge portions and corner portions of the multilayer body tend to be formed into pointed shapes when the multilayer body is formed, and such a case easily leads to issues such as cracks and chips in the ridge portions and the like due to contact of the ridge portions or the corner portions during a manufacturing process of a multilayer ceramic capacitor or during transport in the manufacturing process. To solve such issues, for example, there is a known method of manufacturing a multilayer body such that ridge portions and the like of the multilayer body are rounded by barrel-polishing the multilayer body before or after firing thereof (Japanese Unexamined Patent Application Publication No. 8-316088).

Further, a boundary portion between the end-surface-side ineffective portion and the perpendicular ridge ineffective portion and a boundary portion between the end-surface-side ineffective portion and the horizontal ridge ineffective portion are exposed at end surfaces of the multilayer body before the outer electrode is formed, and cracks and chips are easily generated at these boundary portions due to differences in structures and component compositions. In particular, since surfaces of the boundary portions of the multilayer body after being barrel polished are curved surfaces protruding outward and easily receive a stress, cracks and chips tend to be generated at the boundary portions more easily.

### SUMMARY OF THE INVENTION

Accordingly, example embodiments of the present invention provide multilayer ceramic capacitors in each of which generation of cracks and chips at a boundary portion between an end-surface-side ineffective portion and a perpendicular ridge ineffective portion of a multilayer body or a boundary portion between an end-surface-side ineffective portion and a horizontal ridge ineffective portion thereof is reduced or prevented.

The inventor of example embodiments of the present invention has discovered that forming a protection film including carbon and silicon on a curved surface that includes a boundary portion between an end-surface-side ineffective portion and a perpendicular ridge ineffective portion of a multilayer body or on a curved surface that includes a boundary portion between an end-surface-side ineffective portion and a horizontal ridge ineffective portion thereof reduces or prevents generation of cracks and chips at the boundary portion.

A multilayer ceramic capacitor according to an example embodiment of the present invention includes a multilayer body including a plurality of dielectric layers and a plurality of inner electrode layers that are laminated, and an outer electrode to establish electrical continuity with the inner electrode layers, in which the multilayer body includes an effective portion in which the inner electrode layers overlap each other in a lamination direction and an ineffective portion surrounding the effective portion, two main surfaces opposed to each other in the lamination direction, two end surfaces opposed to each other in a length direction in which the inner electrode layers extend toward the outer electrode, and two side surfaces opposed to each other in a width direction intersecting both of the lamination direction and the length direction, when, in the ineffective portion, regions opposed to each other and sandwiching the effective portion in the length direction are each referred to as an end-surface-side ineffective portion, regions opposed to each other and sandwiching the effective portion in the width direction are each referred to as a side-surface-side ineffective portion, and a region adjacent to the side-surface-side ineffective portion in the length direction and adjacent to the end-surface-side ineffective portion in the width direction is referred to as a perpendicular ridge ineffective portion, an outer surface at a boundary portion between the end-surface-side ineffective portion and the perpendicular ridge ineffective portion, an outer surface of the perpendicular ridge ineffective portion, and an outer surface at a boundary portion between the perpendicular ridge ineffective portion and the side-surface-side ineffective portion define a contiguous curved surface protruding outward in plan view in the lamination direction, and a protection film including carbon and silicon is provided on the curved surface.

In addition, in a multilayer ceramic capacitor according to an example embodiment of the present invention, when, in the ineffective portion, regions opposed to each other and sandwiching the effective portion in the lamination direction are each referred to as a main-surface-side ineffective portion, regions opposed to each other and sandwiching the effective portion in the length direction are each referred to as an end-surface-side ineffective portion, and a region adjacent to the end-surface-side ineffective portion in the lamination direction and adjacent to the main-surface-side ineffective portion in the length direction is referred to as a horizontal ridge ineffective portion, an outer surface at a boundary portion between the end-surface-side ineffective portion and the horizontal ridge ineffective portion, an outer surface of the horizontal ridge ineffective portion, and an outer surface at a boundary portion between the horizontal ridge ineffective portion and the main-surface-side ineffective portion define a contiguous curved surface protruding outward in side view in the width direction, and a protection film including carbon and silicon is provided on the curved surface.

According to example embodiments of the present invention, it is possible to provide multilayer ceramic capacitors in each of which cracks and chips at a boundary portion between an end-surface-side ineffective portion and a perpendicular ridge ineffective portion of a multilayer body and/or a boundary portion between an end-surface-side ineffective portion and a horizontal ridge ineffective portion thereof are reduced or prevented.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view of a multilayer ceramic capacitor according to an example embodiment the present invention.

FIG. 2 is a sectional view of the multilayer ceramic capacitor along the line II-II indicated in FIG. 1.

FIG. 3 is a sectional view of the multilayer ceramic capacitor along the line III-III indicated in FIG. 2.

FIG. 4 is a sectional view of the multilayer ceramic capacitor along the line IV-IV indicated in FIG. 2.

FIG. 5 is a sectional view of the multilayer ceramic capacitor along the line V-V indicated in FIG. 1.

### DETAILED DESCRIPTION OF THE EXAMPLE EMBODIMENTS

Example embodiments of the present invention will be described in detail below with reference to the drawings.

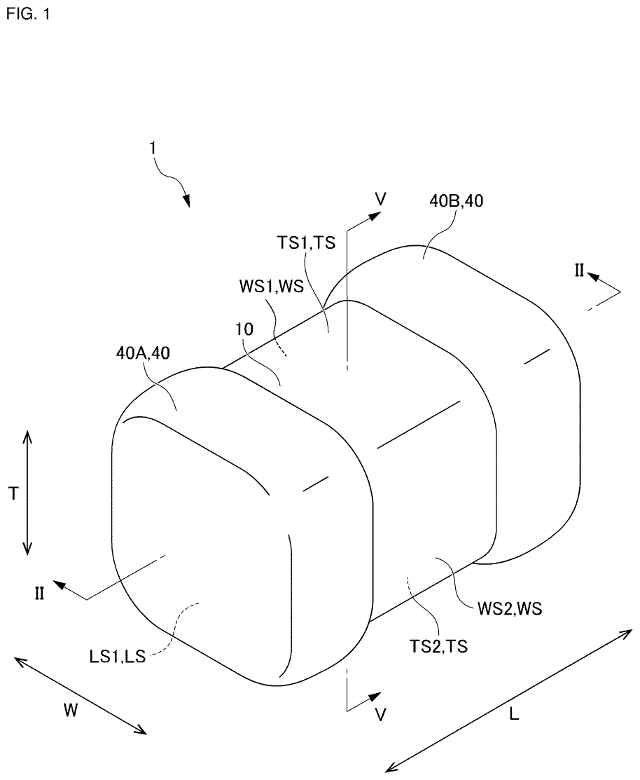

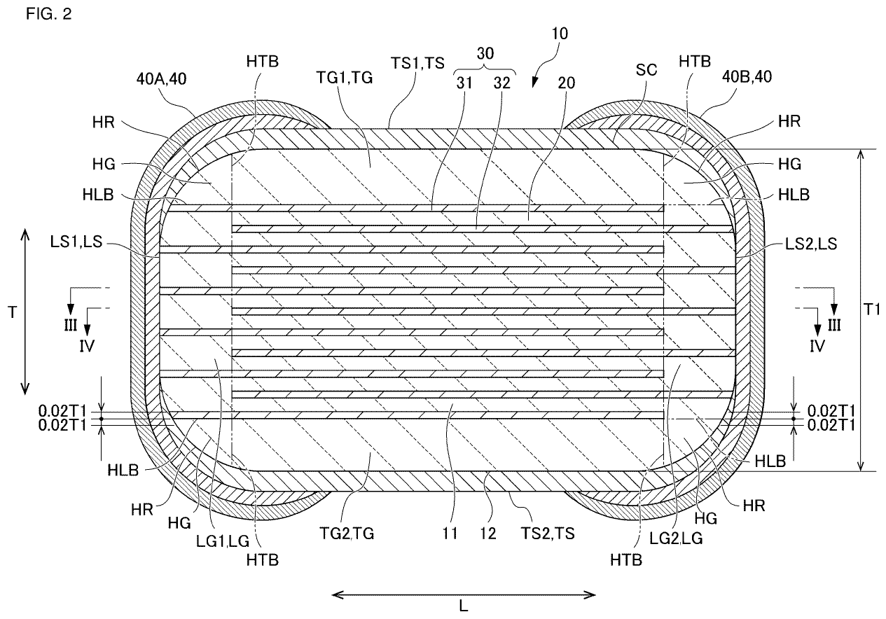

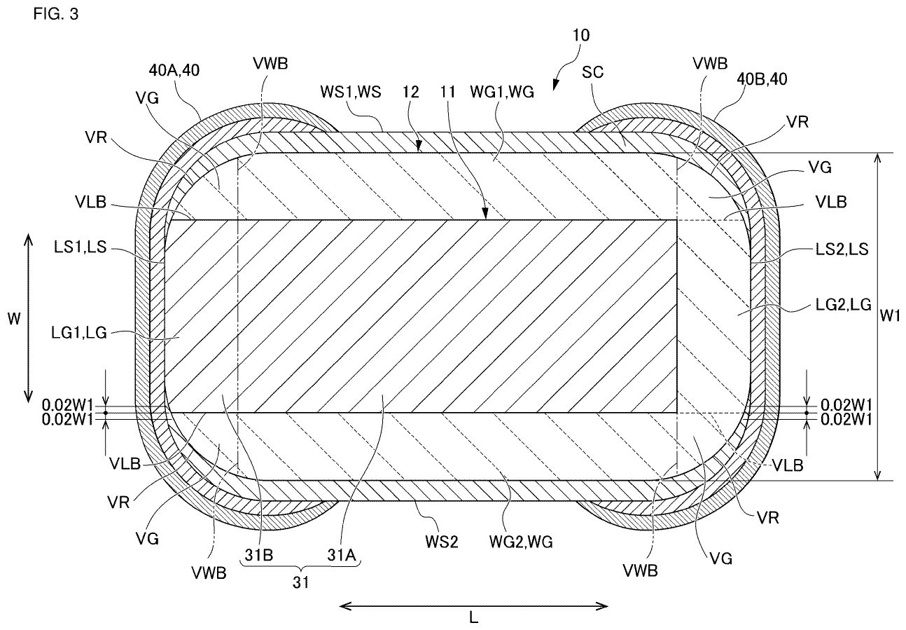

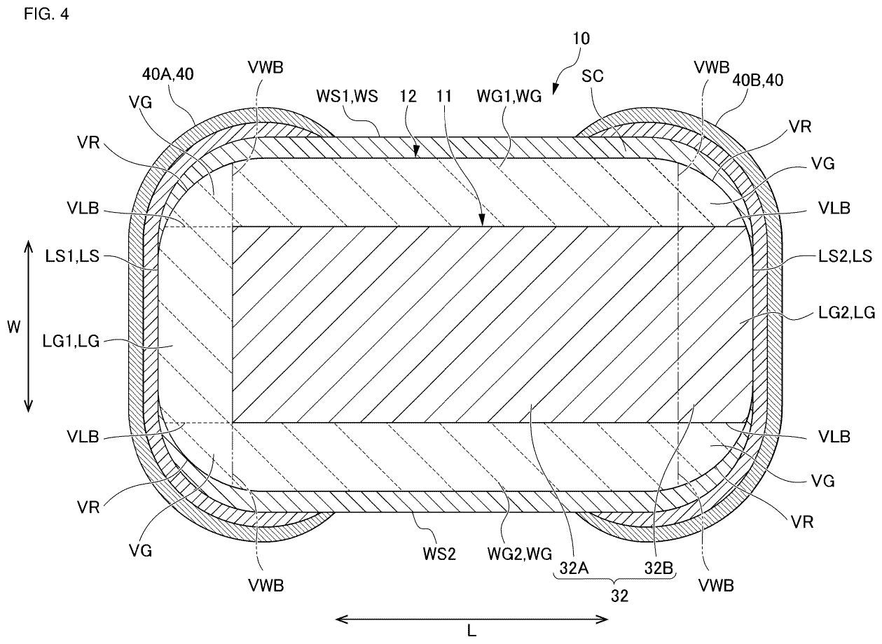

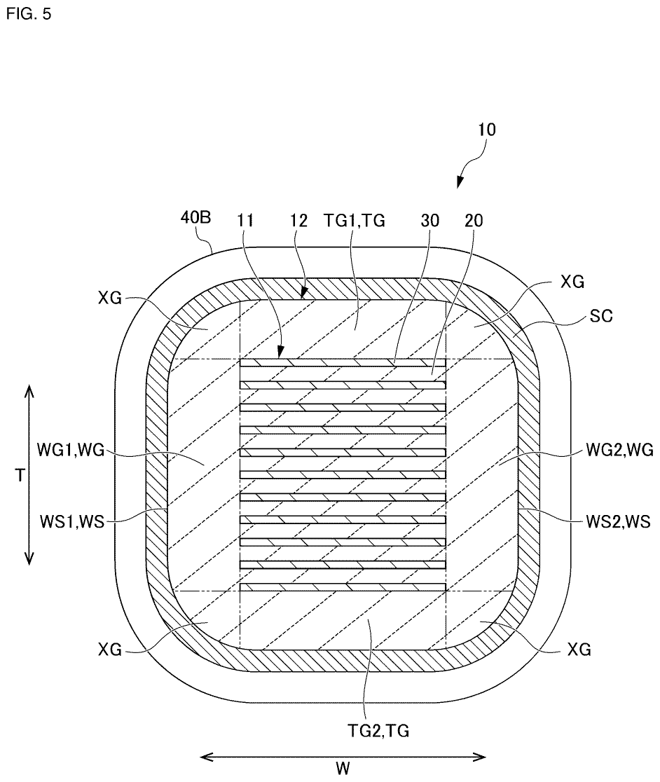

Hereinafter, example embodiments of the present invention will be described. FIG. 1 is a schematic perspective view of a multilayer ceramic capacitor 1 according to an example embodiment of the present invention. FIG. 2 is a sectional view of the multilayer ceramic capacitor 1 along the line II-II indicated in FIG. 1. FIG. 3 is a sectional view of the multilayer ceramic capacitor 1 along the line III-III indicated in FIG. 2. FIG. 4 is a sectional view of the multilayer ceramic capacitor 1 along the line IV-IV indicated in FIG. 2. FIG. 5 is a sectional view of the multilayer ceramic capacitor 1 along the line V-V indicated in FIG. 1. The line II-II passes through a central portion of the multilayer ceramic capacitor 1 in a width direction W, which is described later, and the line V-V passes through a central portion of the multilayer ceramic capacitor 1 in a length direction L, which is described later.

In the following description, as a term representing a direction of the multilayer ceramic capacitor 1, a direction in which a dielectric layer 20 and an inner electrode layer 30 are laminated is referred to as a lamination direction T. A direction intersecting the lamination direction T and in which the inner electrode layer 30 extends toward an outer electrode 40 is referred to as the length direction L. A direction intersecting both the length direction L and the lamination direction T is referred to as a width direction W. In the present example embodiment, the lamination direction T, the length direction L, and the width direction W are orthogonal or substantially orthogonal to each other. In addition, the cross-section illustrated in FIG. 2 is also referred to as an LT cross-section. The cross-section illustrated in FIG. 3 and FIG. 4 is also referred to as an LW cross-section. The cross-section illustrated in FIG. 5 is also referred to as a WT cross-section.

### Multilayer Ceramic Capacitor

The multilayer ceramic capacitor 1 includes a multilayer body 10 that includes a plurality of the dielectric layers 20 and a plurality of the inner electrode layers 30 that are laminated, and a pair of the outer electrodes 40 that are provided at two ends of the multilayer body 10.

### Multilayer Body

The multilayer body 10 has a rectangular or substantially rectangular parallelepiped shape. Corner portions and ridge portions of the multilayer body 10 are rounded. Each corner portion is a portion where three faces of the multilayer body meet, and each ridge portion is a portion where two faces of the multilayer body meet. The dimension of the multilayer body 10 in the length direction L is not necessarily longer than the dimension of the multilayer body 10 in the width direction W. In addition, irregularities or the like may be provided on a portion or all of the surfaces of the multilayer body 10.

Although the dimensions of the multilayer body 10 are not particularly limited, when the dimension of the multilayer body 10 in the length direction L is referred to as a dimension L, the dimension L is, for example, preferably about 0.2 mm or more and about 10 mm or less. In addition, when the dimension of the multilayer body 10 in the lamination direction T is referred to as a dimension T, the dimension T is, for example, preferably about 0.1 mm or more and about 10 mm or less. Further, when the dimension of the multilayer body 10 in the width direction W is referred to as a dimension W, the dimension W is, for example, preferably about 0.1 mm or more and about 10 mm or less.

As illustrated in FIG. 1, the multilayer body 10 includes a first main surface TS1 and a second main surface TS2 opposed to each other in the lamination direction T, a first side surface WS1 and a second side surface WS2 opposed to each other in the width direction W intersecting the lamination direction T, and a first end surface LS1 and a second end surface LS2 opposed to each other in the length direction L intersecting the lamination direction T and the width direction W.

The first main surface TS1 and the second main surface TS2 will be collectively referred to as the main surface TS when distinguish therebetween is not necessary in particular, the first side surface WS1 and the second side surface WS2 will be collectively referred to as the side surface WS when distinguish therebetween is not necessary in particular, and the first end surface LS1 and the second end surface LS2 will be collectively referred to as the end surface LS when distinguish therebetween is not necessary in particular.

### Dielectric Layer

As materials of the plurality of dielectric layers 20 laminated in the multilayer body 10, for example, BaTiO₃, CaTiO₃, SrTiO₃, CaZrO₃, or the like and dielectric ceramics including, as a main component, solid solutions or the like of these substances are usable. In addition, the dielectric layer 20 may include, for example, a Si compound, a Mg compound, a Mn compound, a Al compound, a V compound, a Fe compound, a Cr compound, a Co compound, a Ni compound, or the like. In addition, these compounds may be oxidized substances or carbonated substances.

Although not particularly limited, for example, the thickness of each dielectric layer 20 is preferably about 0.30 μm or more and about 0.50 μm or less and more preferably about 0.30 μm or more and about 0.45 μm or less. Although not particularly limited, for example, the number of the dielectric layers 20 is preferably 100 or more and 2000 or less. This number of the dielectric layers 20 is a total number of the number of the dielectric layers in an effective portion 11 and the number of the dielectric layers in a main-surface-side ineffective portion TG.

### Inner Electrode Layer

The plurality of inner electrode layers 30 laminated in the multilayer body 10 include a first inner electrode layer 31 and a second inner electrode layer 32. A plurality of the first inner electrode layers 31 are disposed on the plurality of dielectric layers 20. A plurality of the second inner electrode layers 32 are disposed on the plurality of dielectric layers 20. The plurality of first inner electrode layers 31 and the plurality of second inner electrode layers 32 are provided alternately in the lamination direction T of the multilayer body 10.

The first inner electrode layer 31 includes a first facing portion 31A facing the second inner electrode layer 32, and a first extension portion 31B extending to the first end surface LS1 from the first facing portion 31A. The first extension portion 31B is exposed at the first end surface LS1.

The second inner electrode layer 32 includes a second facing portion 32A facing the first inner electrode layer 31, and a second extension portion 32B extending to the second end surface LS2 from the second facing portion 32A. The second extension portion 32B is exposed at the second end surface LS2.

The first inner electrode layer 31 and the second inner electrode layer 32 each include, for example, any conductive material, such as metal of Ni, Cu, Ag, Pd, Au, or the like or an alloy including at least one of these metals. When an alloy is used, the first inner electrode layer 31 and the second inner electrode layer 32 may each include, for example, a Ag—Pd alloy or the like.

Preferably, the thickness of each of the first inner electrode layer 31 and the second inner electrode layer 32 is, for example, about 0.2 μm or more and about 3.0 μm or less.

### Effective Portion

The effective portion 11 is a region in which the inner electrode layers 30 overlap each other when the multilayer body 10 is viewed in the lamination direction T. The effective portion 11 is a portion that generates electrostatic capacitance and substantially defines and functions capacitor in the multilayer body 10 by including the first facing portion 31A of the first inner electrode layer 31 and the second facing portion 32A of the second inner electrode layer 32 facing each other with the dielectric layer 20 interposed therebetween.

### Ineffective Portion

An ineffective portion 12 surrounds the effective portion 11 and defines the multilayer body 10 together with the effective portion 11.

The ineffective portion 12 includes two main-surface-side ineffective portions TG, two end-surface-side ineffective portions LG, two side-surface-side ineffective portions WG, four perpendicular ridge ineffective portions VR, four horizontal ridge ineffective portions HR, four long ridge ineffective portions XG, and eight corner-portion ineffective portions.

### Main-Surface-Side Ineffective Portion

As illustrated in FIG. 2, the main-surface-side ineffective portions TG are regions that sandwich the effective portion 11 in the lamination direction T and include a first main-surface-side ineffective portion TG1 and a second main-surface-side ineffective portion TG2.

The first main-surface-side ineffective portion TG1 is positioned on a side of the first main surface TS1 of the multilayer body 10. The first main-surface-side ineffective portion TG1 can be formed by laminating the plurality of dielectric layers 20 as ceramic layers positioned between the first main surface TS1 and the inner electrode layer 30 closest to the first main surface TS1. The dielectric layer 20 used in the first main-surface-side ineffective portion TG1 may be the same as the dielectric layer 20 used in the effective portion 11.

The second main-surface-side ineffective portion TG2 is positioned on a side of the second main surface TS2 of the multilayer body 10. The second main-surface-side ineffective portion TG2 can be formed by laminating the plurality of the dielectric layers 20 as ceramic layers positioned between the second main surface TS2 and the inner electrode layer 30 closest to the second main surface TS2. The dielectric layer 20 used in the second main-surface-side ineffective portion TG2 may be the same as the dielectric layer 20 used in the effective portion 11.

### End-Surface-Side Ineffective Portion

As illustrated in FIG. 3 and FIG. 4, the end-surface-side ineffective portions LG are regions opposed to each other and sandwiching the effective portion 11 in the length direction L and include a first end-surface-side ineffective portion LG1 and a second end-surface-side ineffective portion LG2. The first end-surface-side ineffective portion LG1 is a portion that includes the dielectric layer 20 positioned between the effective portion 11 and the first end surface LS1. The second end-surface-side ineffective portion LG2 is a portion that includes the dielectric layer 20 positioned between the effective portion 11 and the second end surface LS2. In FIG. 2, ranges of the first end-surface-side ineffective portion LG1 and the second end-surface-side ineffective portion LG2 in the LT cross-section of the multilayer ceramic capacitor are illustrated. The end-surface-side ineffective portions LG are also referred to as L gaps or end gaps.

### Side-Surface-Side Ineffective Portion

As illustrated in FIG. 3 and FIG. 4, the side-surface-side ineffective portions WG are regions opposed to each other and sandwiching the effective portion 11 in the width direction W and include a first side-surface-side ineffective portion WG1 and a second side-surface-side ineffective portion WG2. The first side-surface-side ineffective portion WG1 is a portion that includes the dielectric layer 20 positioned between the effective portion 11 and the first side surface WS1. The second side-surface-side ineffective portion WG2 is a portion that includes the dielectric layer 20 positioned between the effective portion 11 and the second side surface WS2. In FIG. 5, ranges of the first side-surface-side ineffective portion WG1 and the second side-surface-side ineffective portion WG2 in the WT cross-section of the multilayer ceramic capacitor are illustrated. The side-surface-side ineffective portions WG are also referred to as W gaps or side gaps.

### Perpendicular Ridge Ineffective Portion

Perpendicular ridge ineffective portions VG are regions adjacent to the side-surface-side ineffective portions WG in the length direction L and adjacent to the end-surface-side ineffective portions LG in the width direction W.

As illustrated in FIG. 3 and FIG. 4, the perpendicular ridge ineffective portions VG are disposed at four corners of the multilayer body 10 as viewed in the lamination direction T.

### Horizontal Ridge Ineffective Portion

Horizontal ridge ineffective portions HG are regions adjacent to the end-surface-side ineffective portions LG in the lamination direction T and adjacent to the main-surface-side ineffective portions TG in the length direction L.

As illustrated in FIG. 2, the horizontal ridge ineffective portions HG are disposed at four corners of the multilayer body 10 as viewed in the width direction W.

### Long Ridge Ineffective Portion

The long ridge ineffective portions XG are regions adjacent to the side-surface-side ineffective portions WG in the lamination direction T and adjacent to the main-surface-side ineffective portions TG in the width direction W.

As illustrated in FIG. 5, the long ridge ineffective portions XG are disposed at four corners of the multilayer body 10 as viewed in the length direction L.

### Corner-Portion Ineffective Portion

The corner-portion ineffective portions are regions surrounded by the perpendicular ridge ineffective portions VG, the horizontal ridge ineffective portions HG, and the long ridge ineffective portions XG and are disposed at eight corner portions of the multilayer body 10.

Thus, the multilayer body 10 has a structure in which the effective portion 11 is surrounded by the ineffective portion 11 including the two main-surface-side ineffective portions TG, the two side-surface-side ineffective portions WG, the two end-surface-side ineffective portions LG, the four perpendicular ridge ineffective portions VR, the four horizontal ridge ineffective portions HR, the four long ridge ineffective portions XG, and the eight corner-portion ineffective portions.

### Curved Surface

As illustrated in FIG. 3 and FIG. 4, in the multilayer ceramic capacitor 1 according to the present example embodiment, an outer surface at a boundary portion VLB between the end-surface-side ineffective portion LG and the perpendicular ridge ineffective portion VG, an outer surface of the perpendicular ridge ineffective portion VG, and an outer surface at a boundary portion VWB between the perpendicular ridge ineffective portion VG and the side-surface-side ineffective portion WG define a contiguous curved surface VR protruding outward in plan view in the lamination direction T.

In the LW cross-section parallel or substantially parallel to the length direction L and the width direction W of the multilayer body 10, when the length of the multilayer body 10 at the center of the multilayer body 10 in the width direction W is referred to as W1, the length of the multilayer body 10 in the length direction L at a position shifted by about 0.02 W1 from the boundary portion VLB between the end-surface-side ineffective portion LG and the perpendicular ridge ineffective portion VG toward the side surface WS is shorter than the length of the multilayer body 10 in the length direction L at a position shifted by about 0.02 W1 from the boundary portion VLB between the end-surface-side ineffective portion LG and the perpendicular ridge ineffective portion VG toward the center of the multilayer body 10 in the width direction W.

Such a shape of the curved surface VR near the boundary portion VLB can be obtained by subjecting the multilayer body before or after firing thereof to barrel polishing processing, for example.

In addition, as illustrated in FIG. 2, in the multilayer ceramic capacitor 1, an outer surface at a boundary portion HLB between the end-surface-side ineffective portion LG and the horizontal ridge ineffective portion HG, an outer surface of the horizontal ridge ineffective portion HG, an outer surface at a boundary portion HTB between the horizontal ridge ineffective portion HG and the main-surface-side ineffective portion TG define a contiguous curved surface HR protruding outward in side view in the width direction W.

In the LT cross-section parallel or substantially parallel to the length direction L and the lamination direction T of the multilayer body 10, when the length of the multilayer body 10 at the center of the multilayer body 10 in the lamination direction T is referred to as T1, the length of the multilayer body 10 in the length direction L at a position shifted by about 0.02 T1 from the boundary portion HLB between the end-surface-side ineffective portion LG and the horizontal ridge ineffective portion HG toward the main surface TS is shorter than the length of the multilayer body 10 in the length direction L at a position shifted by about 0.02 T1 from the boundary portion HLB between the end-surface-side ineffective portion LG and the horizontal ridge ineffective portion HG toward the center of the multilayer body 10 in the lamination direction T.

Such a shape of the curved surface HR near the boundary portion HLB can be obtained by subjecting the multilayer body before or after firing thereof to barrel polishing processing, for example.

Subjecting the multilayer body 10 to the barrel polishing processing can concurrently form the contiguous curved surface VR, which is provided by the outer surface at the boundary portion VLB between the end-surface-side ineffective portion LG and the perpendicular ridge ineffective portion VG, the outer surface of the perpendicular ridge ineffective portion VG, and the outer surface at the boundary portion VWB between the perpendicular ridge ineffective portion VG and the side-surface-side ineffective portion WG, and the contiguous curved surface HR, which is provided by the outer surface at the boundary portion HLB between the end-surface-side ineffective portion LG and the horizontal ridge ineffective portion HG, the outer surface of the horizontal ridge ineffective portion HG, and the outer surface at the boundary portion HTB between the horizontal ridge ineffective portion HG and the main-surface-side ineffective portion TG.

Barrel polishing may be performed at one time and may be divided and performed at multiple times. When barrel polishing is divided and performed at multiple times, the number of rotations may be varied for each time.

### Protection Film

As illustrated in FIG. 3 and FIG. 4, a protective film SC including carbon and silicon is provided on the contiguous curved surface VR, which is provided by the outer surface at the boundary portion VLB between the end-surface-side ineffective portion LG and the perpendicular ridge ineffective portion VG, the outer surface of the perpendicular ridge ineffective portion VG, and the outer surface at the boundary portion VWB between the perpendicular ridge ineffective portion VG and the side-surface-side ineffective portion WG. Providing such a protection film SC can protect the boundary portion VLB between the end-surface-side ineffective portion LG and the perpendicular ridge ineffective portion VG and reduce or prevent generation of cracks and chips at the boundary portion VLB. In addition, the protection film SC can protect the boundary portion VWB between the perpendicular ridge ineffective portion VG and the side-surface-side ineffective portion WG and reduce or prevent generation of cracks and chips at the boundary portion VWB.

In particular, when, for example, the thickness of the side-surface-side ineffective portion WG in the width direction W is about 20 μm or less, cracks and chips tend to be generated easily at the boundary portion VLB between the end-surface-side ineffective portion LG and the perpendicular ridge ineffective portion VG of the multilayer body 10. However, generation of cracks and chips at the boundary portion VLB can be effectively reduced or prevented even when the thickness of the side-surface-side ineffective portion WG in the width direction W is about 20 μm or less by, as in example embodiments of the present invention, providing the outer surface at the boundary portion VLB between the end-surface-side ineffective portion LG and the perpendicular ridge ineffective portion VG, the outer surface of the perpendicular ridge ineffective portion VG, and the outer surface at the boundary portion VWB between the perpendicular ridge ineffective portion VG and the side-surface-side ineffective portion WG into the contiguous curved surface VR and providing the protection film SC on the curved surface VR.

The protection film SC is preferably provided on the outer surface of the side-surface-side ineffective portion WG contiguously from the curved surface VR. With the protection by the protection film SC provided on the outer surface of the side-surface-side ineffective portion WG contiguously from the curved surface VR, the strength of the multilayer ceramic capacitor can be further improved.

It is sufficient for the protection film SC to be provided on the curved surface VR, and the protection film SC is not necessarily also contiguously provided on the outer surface of the side-surface-side ineffective portion WG. In addition, the protection film SC provided on the outer surface of the side-surface-side ineffective portion WG does not necessarily protect the entirety of the outer surface of the side-surface-side ineffective portion WG.

As illustrated in FIG. 2, the protection film SC including carbon and silicon is provided on the outer surface at the boundary portion HLB between the end-surface-side ineffective portion LG and the horizontal ridge ineffective portion LG and on the contiguous curved surface HR, which is provided by the outer surface of the horizontal ridge ineffective portion HG and the outer surface at the boundary portion HTB between the horizontal ridge ineffective portion HG and the main-surface-side ineffective portion TG. By providing such a protection film SC, it is possible to protect the boundary portion HLB between the end-surface-side ineffective portion LG and the horizontal ridge ineffective portion HG and reduce or prevent generation of cracks and chips at the boundary portion HLB. In addition, the protection film SC can protect the boundary portion HTB between the horizontal ridge ineffective portion HG and the main-surface-side ineffective portion TG and reduce or prevent generation of cracks and chips at the boundary portion HTB.

In particular, when the thickness of the main-surface-side ineffective portion TG in the lamination direction T is, for example, about 40 μm or less, cracks and chips tend to be generated easily at the boundary portion HLB between the end-surface-side ineffective portion LG and the horizontal ridge ineffective portion HG of the multilayer body 10. However, generation of cracks and chips at the boundary portion HLB can be effectively reduced or prevented even when the thickness of the main-surface-side ineffective portion TG in the lamination direction T is about 40 μm or less by, as in example embodiments of the present invention, providing the outer surface at the boundary portion HLB between the end-surface-side ineffective portion LG and the horizontal ridge ineffective portion HG, the outer surface of the horizontal ridge ineffective portion HG, and the outer surface at the boundary portion HTB between the horizontal ridge ineffective portion HG and the main-surface-side ineffective portion TG into the contiguous curved surface HR and providing the protection film SC on the curved surface HR. Further, even when the thickness of the main-surface-side ineffective portion TG in the lamination direction T is, for example, about 25 μm or less, generation of cracks and chips at the boundary portion HLB can be reliably reduced or prevented by providing the protection film SC on the curved surface HR.

The protection film SC is preferably provided on the outer surface of the main-surface-side ineffective portion TG contiguously from the curved surface HR. With the protection by the protection film SC provided on the outer surface of the main-surface-side ineffective portion TG contiguously from the curved surface HR, the strength of the multilayer ceramic capacitor can be further improved.

It is sufficient for the protection film SC to be provided on the curved surface HR, and the protection film SC is not necessarily also contiguously provided on the outer surface of the main-surface-side ineffective portion TG. In addition, the protection film SC provided on the outer surface of the main-surface-side ineffective portion TG does not necessarily protect the entirety of the outer surface of the main-surface-side ineffective portion TG.

The protection film SC can be formed by, for example, a plasma spraying method, an aerosol deposition method, or the like. A base material of the protection film SC is, for example, silicon carbide to which a metal oxide such as alumina, magnesia, zirconia, or titania, a silicon nitride, or a mixture thereof is added.

The plasma spraying method is a coating method of obtaining a thermal sprayed coating by ejecting a working gas as a plasma jet by an arc generated between electrodes, injecting a thermal spray material into the plasma jet, and heating and accelerating the thermal spray material to be deposited on the multilayer body 10.

The aerosol deposition method is a method of forming a coating including a fine particle material onto a base member by ejecting an aerosol in which fine particles of raw material ceramics are dispersed in a gas toward the multilayer body 10, which is the base member, through an aerosol ejection nozzle to cause the aerosol to collide with a surface of this base member at a high speed. In forming of a coating by the aerosol deposition method, ceramic fine particles maintain a dispersed state in the aerosol. Since the coating obtained by the aerosol deposition method is a coating formed from fine particles dispersed in aerosol, the protection film SC obtained is formed as a fine film.

The protection film SC may be formed by, for example, laminating two or more coating layers. In forming by laminating, for example, either one of the plasma spraying method and the aerosol deposition method may be repeatedly used or forming by laminating may be performed by a combination of the two methods (for example, the aerosol deposition method for a first layer, the plasma spraying method for a second layer, and the like).

The thickness of the protection film SC is, for example, preferably about 10 nm or more and about 100 nm or less to reliably protect the curved surface VR or the curved surface HR. When the thickness of the protection film SC is less than about 10 nm, it is not possible to maintain sufficient strength, and when the thickness of the protection film SC is more than about 100 nm, a ceramic capacitor manufacturing process, which is described later, requires a longer time for a step of subjecting the end surface LS of the multilayer body 10 to sandblast processing to shave off a portion of the protection film SC and expose an extension portion of the inner electrode layer 30.

### Outer Electrode

The outer electrode 40 includes a first outer electrode 40A and a second outer electrode 40B.

The first outer electrode 40A is disposed on a side of the first end surface LS1 and connected to the first inner electrode layer 31. The second outer electrode 40B is disposed on a side of the second end surface LS2 and connected to the second inner electrode layer 32.

As illustrated in FIG. 3 and FIG. 4, the first outer electrode 40A can be also disposed at, in addition to the first end-surface-side ineffective portion LG1 defining the first end surface LS1, a portion of each of the first side surface WS1 and the second side surface WS2 so as to cover the protection film SC provided on the curved surface VR and on the outer surface of the side-surface-side ineffective portion WG. The second outer electrode 40B can be also disposed at, in addition to the second end-surface-side ineffective portion LG2 defining the second end surface LS2, a portion of each of the first side surface WS1 and the second side surface WS2 so as to cover the protection film SC provided on the curved surface VR and on the outer surface of the side-surface-side ineffective portion WG.

As illustrated in FIG. 2, the first outer electrode 40A can be also disposed at, in addition to the first end-surface-side ineffective portion LG1 defining the first end surface LS1, a portion of each of the first main surface TS1 and the second main surface TS2 so as to cover the protection film SC provided on the curved surface HR and on the outer surface of the main-surface-side ineffective portion TG. The second outer electrode 40B can be also disposed at, in addition to the second end-surface-side ineffective portion LG2 defining the second end surface LS2, a portion of each of the first main surface TS1 and the second main surface TS2 so as to cover the protection film SC provided on the curved surface HR and on the outer surface of the main-surface-side ineffective portion TG.

Inside the multilayer body 10, the first facing portion 31A of the first inner electrode layer 31 and the second facing portion 32A of the second inner electrode layer 32 face each other with the dielectric layer 20 interposed therebetween and thus generate capacitance. Therefore, a function of a capacitor is exerted between the first outer electrode 40A to which the first inner electrode layer 31 is connected and the second outer electrode 40B to which the second inner electrode layer 32 is connected.

The first outer electrode 40A and the second outer electrode 40B can each include, for example, a base electrode layer and a plating layer disposed on the base electrode layer. The base electrode layer is formed by applying conductive paste including a metal component and a glass component to the first end surface LS1 and the second end surface LS2 of the multilayer body 10 and then baking the conductive paste. As the metal component blended in the conductive paste, for example, a metal such as Cu, Ni, Ag, Pd or Au or an alloy of Ag and Pd or the like is usable.

The plating layer disposed on the base electrode layer includes, for example, at least one of metals of Cu, Ni, Ag, Pd, or Au or an alloy of Ag and Pd or the like. The plating layer may have, for example, a two-layer structure including a Ni plating layer and a Sn plating layer. The plating layer may include a single layer and may include multiple layers.

### Manufacturing Method

A multilayer ceramic capacitor can be manufactured by, for example, forming a multilayer body including an effective portion in which a plurality of inner electrode layers and dielectric layers are laminated and disposing an outer electrode so as to be connected to end portions of the inner electrode layers exposed at an end surface of the multilayer body.

### Formation of Multilayer Body

First, ceramic green sheets for dielectric layers and conductive paste for inner electrode layers are prepared. The ceramic green sheets and the conductive paste for inner electrode layers each include a binder and a solvent. The binder and the solvent may be a publicly known binder and a publicly known solvent.

Then, the conductive paste for inner electrode layers is printed into a predetermined pattern on each ceramic green sheet by, for example, screen printing, gravure printing, or the like. Consequently, the ceramic green sheet on which a pattern of a first inner electrode layer is formed and the ceramic green sheet on which a pattern of a second inner electrode layer is formed are prepared. The conductive paste for inner electrode layers is, for example, a paste in which an organic binder and an organic solvent are added to metal powder. Regarding the ceramic green sheets, ceramic green sheets for ineffective portions and on each of which a pattern of an inner electrode layer is not printed are also created.

Next, a predetermined number of the ceramic green sheets for ineffective portions and on each of which a pattern of an inner electrode layer is not printed are laminated, and portions that become the second main-surface-side ineffective portion and the horizontal ridge ineffective portion are thereby formed. On the portions, the ceramic green sheet on which the pattern of the first inner electrode layer is printed and the ceramic green sheet on which the pattern of the second inner electrode layer is printed are laminated sequentially so as to form the structure of example embodiments of the present invention, and portions that become the effective portion, the end-surface-side ineffective portion, the side-surface-side ineffective portion, and the perpendicular ridge ineffective portion are thus formed. On the portions that become the effective portion and the like, a predetermined number of the ceramic green sheets for ineffective portions and on each of which a pattern of an inner electrode layer is not printed are laminated, and portions that become the first main-surface-side ineffective portion and the horizontal ridge ineffective portion are thus formed. Consequently, a laminated sheet is created.

Next, the laminated sheet is pressed in the lamination direction by, for example, an isostatic press, and a multilayer block is thus created.

Then, the multilayer block is cut to a predetermined size, and a multilayer chip is thereby cut out. At this time, corner portions and ridge portions of the multilayer chip are rounded by, for example, barrel polishing or the like.

Through the barrel polishing, a surface of the boundary portion VLB between the end-surface-side ineffective portion LG and the perpendicular ridge ineffective portion VG, a surface of the perpendicular ridge ineffective portion VG, and a surface of the boundary portion VWB between the perpendicular ridge ineffective portion VG and the side-surface-side ineffective portion WG can be formed into the contiguous curved surface VR protruding outward in plan view in the lamination direction T.

Similarly, through the barrel polishing, a surface of the boundary portion HLB between the end-surface-side ineffective portion LG and the horizontal ridge ineffective portion HG, a surface of the horizontal ridge ineffective portion HG, and a surface of the boundary portion HTB between the horizontal ridge ineffective portion HG and the main-surface-side ineffective portion TG can be formed into the contiguous curved surface HR protruding outward in side view in the width direction W.

Next, the multilayer chip is fired, and the multilayer body 10 is thus created. The temperature of firing depends on materials of dielectrics and inner electrode layers but is, for example, preferably about 900° C. or higher and about 1400° C. or lower.

### Formation of Protection Film

The protection film SC including carbon and silicon can be formed on a surface of the multilayer body 10 by, for example, a plasma spraying method, an aerosol deposition method, or the like with silicon carbide used as a base material.

Next, the end surface LS of the multilayer body 10 is subjected to sandblast processing to expose an extension portion of each of the inner electrode layers 30 through the end surface LS.

To protect the protection film SC, a masking agent is applied to the curved surface VR, which is defined by the outer surface of the boundary portion VLB between the end-surface-side ineffective portion LG and the perpendicular ridge ineffective portion VG, the outer surface of the perpendicular ridge ineffective portion VG, and the outer surface of the boundary portion VWB between the perpendicular ridge ineffective portion VG and the side-surface-side ineffective portion WG.

In addition, to protect the protection film SC, a masking agent is applied to the curved surface HR, which is defined by the outer surface of the boundary portion HLB between the end-surface-side ineffective portion LG and the horizontal ridge ineffective portion HG, the outer surface of the horizontal ridge ineffective portion HG, the outer surface of the boundary portion HTB between the horizontal ridge ineffective portion HG and the main-surface-side ineffective portion TG.

Examples of a blast material to be used in blasting processing are steel, stainless steel, zirconia, alumina, silica, silicon carbide or the like, resins, rubber, and the like.

The shape of the blast material may be spherical and may be non-spherical.

The blasting processing may be, for example, dry-type blast (dry blast) or may be wet-type blast (wet blast).

### Formation of Outer Electrode

Although not particularly limited, an example of the method for forming an outer electrode at an end surface of a multilayer body is a method in which conductive paste is applied to an end surface of a multilayer body and fired.

The conductive paste for forming an outer electrode at an end portion of a multilayer body includes metal and glass and may include, as necessary, resin, for example.

As the metal, for example, at least one of Cu, Ni, Ag, Pd, a Ag—Pd alloy, or Au is preferably included.

As the glass, for example, B—Si based glass, B—Si—Zn based glass, B—Si—Zn—Ba based glass, B—Si—Zn—Ba—Ca—Al based glass, or the like is usable.

A plating layer may be further formed on a surface of the outer electrode obtained by firing the conductive paste.

Although not particularly limited, the composition of the plating layer formed on the surface of the outer electrode preferably includes, for example, at least one of Cu, Ni, Ag, Pd, a Ag—Pd alloy, Au, or Sn, or two or more layers whose compositions are different from each other may be laminated in the plating layer.

As the plating layer including two or more layers, for example, a plating layer defined by a Ni plating layer (first layer) in direct contact with the outer electrode and a Sn plating layer (second layer) not in direct contact with the outer electrode is preferable.

Preferably, for example, the thickness of the Ni layer is about 1 μm or more and about 8 μm or less, and the thickness of the Sn layer is about 1 μm or more and about 8 μm or less.

When the Ni plating layer is formed, erosion in the outer electrode due to a solder for mounting of the multilayer ceramic capacitor can be reduced or prevented. When the Sn plating layer is formed, wettability improves and thus makes mounting of the multilayer ceramic capacitor easier.

Through the above steps, the multilayer ceramic capacitor is manufactured.

### EXAMPLES

Samples of multilayer ceramic capacitors in an example of an example embodiment of the present invention and a comparative example presented below were manufactured, and the samples were evaluated through drop tests.

### Example

Twenty multilayer ceramic capacitors in each of which the protection film SC is provided on each of the curved surface VR, which is defined by the outer surface of the boundary portion VLB between the end-surface-side ineffective portion LG and the perpendicular ridge ineffective portion VG, the outer surface of the perpendicular ridge ineffective portion VG, the outer surface of the boundary portion VWB between the perpendicular ridge ineffective portion VG and the side-surface-side ineffective portion WG, and the curved surface HR, which is formed by the outer surface of the boundary portion HLB between the end-surface-side ineffective portion LG and the horizontal ridge ineffective portion HG, the outer surface of the horizontal ridge ineffective portion HG, and the outer surface of the boundary portion HTB between the horizontal ridge ineffective portion HG and the main-surface-side ineffective portion TG, were prepared.

### Comparative Example

Twenty multilayer ceramic capacitors created in the same or substantially the same manner as that for the example described above except for not providing the protection film SC on the curved surface VR and the curved surface HR were prepared.

### Drop Test

The twenty multilayer ceramic capacitors of the present example were accommodated in a container, and an operation of dropping the container from a height of about 20 cm was repeated twenty times.

Similarly, the twenty multilayer ceramic capacitors of the comparative example were accommodated in a container, and an operation of dropping the container from a height of about 20 cm was repeated twenty times.

After the drop tests were completed, generation of chips were confirmed. The chips include large chips and small chips. When the length of the multilayer ceramic capacitor in the width direction W at the center of the multilayer ceramic capacitor in the length direction L is referred to as LW, a large chip is a chip having a size of more than or equal to LW/4. A small chip is a chip smaller than the large chip.

The total number of portions in each of which a large chip or a small chip was generated is indicated below. This total number is obtained by adding up the numbers of chips generated in the multilayer ceramic capacitors.
Example: 51 portions
Comparative example: 71 portions

Next, the number of the multilayer ceramic capacitors in each of which a large chip was generated is indicated below.
Example: 10
Comparative example: 13

As a result of the drop tests, an advantageous effect of reducing or preventing chips in the multilayer body can be confirmed for the multilayer ceramic capacitor according to an example embodiment of the present invention.

Although an example embodiment of the present invention has been described above, the present invention is not limited to the example embodiment and can be provided in various forms within a scope not departing from the gist of the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a plurality of dielectric layers and a plurality of inner electrode layers that are laminated; and
an outer electrode to establish electrical continuity with the inner electrode layers; wherein
the multilayer body includes an effective portion in which the inner electrode layers overlap each other in a lamination direction and an ineffective portion surrounding the effective portion;
the multilayer body includes two main surfaces opposed to each other in the lamination direction, two end surfaces opposed to each other in a length direction in which the inner electrode layers extend toward the outer electrode, and two side surfaces opposed to each other in a width direction intersecting both of the lamination direction and the length direction;
when, in the ineffective portion, regions opposed to each other and sandwiching the effective portion in the length direction are each referred to as an end-surface-side ineffective portion, regions opposed to each other and sandwiching the effective portion in the width direction are each referred to as a side-surface-side ineffective portion, and a region adjacent to the side-surface-side ineffective portion in the length direction and adjacent to the end-surface-side ineffective portion in the width direction is referred to as a perpendicular ridge ineffective portion, an outer surface at a boundary portion between the end-surface-side ineffective portion and the perpendicular ridge ineffective portion, an outer surface of the perpendicular ridge ineffective portion, and an outer surface at a boundary portion between the perpendicular ridge ineffective portion and the side-surface-side ineffective portion define a contiguous curved surface protruding outward in plan view in the lamination direction; and
a protection film including carbon and silicon is provided on the curved surface.

2. The multilayer ceramic capacitor according to claim 1, wherein a thickness of the side-surface-side ineffective portion in the width direction is about 20 μm or less.

3. The multilayer ceramic capacitor according to claim 1, wherein the protection film is provided on an outer surface of the side-surface-side ineffective portion contiguously from the curved surface.

4. The multilayer ceramic capacitor according to claim 1, wherein, in a cross-section parallel or substantially parallel to the length direction and the width direction of the multilayer body, when a length of the multilayer body at a center of the multilayer body in the width direction is referred to as W1, a length of the multilayer body in the length direction at a position shifted by about 0.02 W1 from the boundary portion between the end-surface-side ineffective portion and the perpendicular ridge ineffective portion toward each of the side surfaces is shorter than a length of the multilayer body in the length direction at a position shifted by about 0.02 W1 from the boundary portion between the end-surface-side ineffective portion and the perpendicular ridge ineffective portion toward the center of the multilayer body in the width direction.

5. The multilayer ceramic capacitor according to claim 1, wherein a thickness of the protection film is about 10 nm or more and about 100 nm or less.

6. The multilayer ceramic capacitor according to claim 1, wherein
a dimension of the multilayer body in the length direction is about 0.2 mm or more and about 10 mm or less;
a dimension of the multilayer body in the lamination direction is about 0.1 mm or more and about 10 mm or less; and
a dimension of the multilayer body in the width direction is about 0.1 mm or more and about 10 mm or less.

7. The multilayer ceramic capacitor according to claim 1, wherein each of the dielectric layers includes BaTiO₃, CaTiO₃, SrTiO₃, or CaZrO₃ as a main component.

8. The multilayer ceramic capacitor according to claim 7, wherein each of the plurality of dielectric layers includes a Si compound, a Mg compound, a Mn compound, a Al compound, a V compound, a Fe compound, a Cr compound, a Co compound, or a Ni compound as a subcomponent.

9. The multilayer ceramic capacitor according to claim 1, wherein a thickness of each of the dielectric layers is about 0.30 μm or more and about 0.50 μm or less and more preferably about 0.30 μm or more and about 0.45 μm or less.

10. The multilayer ceramic capacitor according to claim 1, wherein each of the inner electrode layers includes Ni, Cu, Ag, Pd, or Au, or an alloy including at least one of Ni, Cu, Ag, Pd, or Au.

11. A multilayer ceramic capacitor comprising:
a multilayer body including a plurality of dielectric layers and a plurality of inner electrode layers that are laminated; and
an outer electrode to establish electrical continuity with the inner electrode layers; wherein
the multilayer body includes an effective portion in which the inner electrode layers overlap each other in a lamination direction and an ineffective portion surrounding the effective portion;
the multilayer body includes two main surfaces opposed to each other in the lamination direction, two end surfaces opposed to each other in a length direction in which the inner electrode layers extend toward the outer electrode; and
two side surfaces opposed to each other in a width direction intersecting both of the lamination direction and the length direction; and
when, in the ineffective portion, regions opposed to each other and sandwiching the effective portion in the lamination direction are each referred to as a main-surface-side ineffective portion, regions opposed to each other and sandwiching the effective portion in the length direction are each referred to as an end-surface-side ineffective portion, and a region adjacent to the end-surface-side ineffective portion in the lamination direction and adjacent to the main-surface-side ineffective portion in the length direction is referred to as a horizontal ridge ineffective portion;
an outer surface at a boundary portion between the end-surface-side ineffective portion and the horizontal ridge ineffective portion, an outer surface of the horizontal ridge ineffective portion, and an outer surface at a boundary portion between the horizontal ridge ineffective portion and the main-surface-side ineffective portion define a contiguous curved surface protruding outward in side view in the width direction; and
a protection film including carbon and silicon is provided on the curved surface.

12. The multilayer ceramic capacitor according to claim 11, wherein a thickness of the main-surface-side ineffective portion in the lamination direction is about 40 μm or less.

13. The multilayer ceramic capacitor according to claim 11, wherein the protection film is provided on an outer surface of the main-surface-side ineffective portion contiguously from the curved surface.

14. The multilayer ceramic capacitor according to claim 11, wherein, in a cross-section parallel or substantially parallel to the length direction and the lamination direction of the multilayer body, when a length of the multilayer body at a center of the multilayer body in the lamination direction is referred to as T1, a length of the multilayer body in the length direction at a position shifted by about 0.02 T1 from the boundary portion between the end-surface-side ineffective portion and the horizontal ridge ineffective portion toward each of the main surfaces is shorter than a length of the multilayer body in the length direction at a position shifted by about 0.02 T1 from the boundary portion between the end-surface-side ineffective portion and the horizontal ridge ineffective portion toward the center of the multilayer body in the lamination direction.

15. The multilayer ceramic capacitor according to claim 11, wherein a thickness of the protection film is about 10 nm or more and about 100 nm or less.

16. The multilayer ceramic capacitor according to claim 11, wherein
a dimension of the multilayer body in the length direction is about 0.2 mm or more and about 10 mm or less;
a dimension of the multilayer body in the lamination direction is about 0.1 mm or more and about 10 mm or less; and
a dimension of the multilayer body in the width direction is about 0.1 mm or more and about 10 mm or less.

17. The multilayer ceramic capacitor according to claim 11, wherein each of the dielectric layers includes BaTiO₃, CaTiO₃, SrTiO₃, or CaZrO₃ as a main component.

18. The multilayer ceramic capacitor according to claim 17, wherein each of the plurality of dielectric layers includes a Si compound, a Mg compound, a Mn compound, a Al compound, a V compound, a Fe compound, a Cr compound, a Co compound, or a Ni compound as a subcomponent.

19. The multilayer ceramic capacitor according to claim 11, wherein a thickness of each of the dielectric layers is about 0.30 μm or more and about 0.50 μm or less.

20. The multilayer ceramic capacitor according to claim 11, wherein each of the inner electrode layers includes Ni, Cu, Ag, Pd, or Au, or an alloy including at least one of Ni, Cu, Ag, Pd, or Au.
